(19) United States
(12) Patent Application Publication
(10) Pub. No.: US 2014/0217979 A1
(43) Pub. Date: Aug. 7, 2014

(54) METHOD AND DEVICE FOR OPTIMIZED RECHARGING OF AN ELECTRIC BATTERY

(71) Applicants: Melaine Rousselle, Vanves (FR); Gaizka Alberdi, Vanves (FR)

(72) Inventors: Melaine Rousselle, Vanves (FR); Gaizka Alberdi, Vanves (FR)

(73) Assignees: ELECTRICITE RESEAU DISTRIBUTION FRANCE, Paris la Defense Cedex (FR); ELECTRICITE DE FRANCE, Paris (FR)

(21) Appl. No.: 14/343,570

(22) PCT Filed: Sep. 6, 2012
(86) PCT No.: PCT/FR2012/051992

§ 371 Date: Mar. 7, 2014

(30) Foreign Application Priority Data
Sep. 7, 2011 (FR) 11 57961

(51) Int. Cl. B60L 11/18

(52) U.S. Cl. CPC B60L 11/1844
USPC 320/109; 320/155

(57) ABSTRACT

A method and device for optimized recharging of the electric battery of an electrical system by an electrical recharging device, in which the electric battery is recharged during a charging time period belonging to an available charging time period initiated by the connecting of the recharging system of the electric battery to the electrical recharging device, this charging time period starting at a start of charge instant determined as a function of a charging curve associated with said electrical recharging device, of a charging limit power level and of the level of residual electrical energy contained in the electric battery upon the connecting of the electric battery charging system to the electrical recharging device.

The invention relates to the field of managing the recharging of electric batteries, particularly the recharging of electric batteries of electric vehicles.

There are currently many electrical systems comprising a system for storing electrical energy, in particular a system consisting of one or more electric batteries and their associated recharging system, which can be connected to a electrical grid for recharging.

These electrical systems include electric vehicles having an electrical energy storage system which can be connected to power supply terminals by means of a recharging plug. The power supply terminals are each connected to the electrical grid.

Usually, charging the electric battery of such electrical systems begins the moment this battery is connected to the electrical grid and ends when this electric battery is disconnected from the electrical grid.

In the specific case of electric vehicles, the recharging begins the moment the recharging plug of the electric vehicle is plugged into the power supply terminal and continues as long as the electric vehicle is not unplugged, meaning until the user of the vehicle wishes to claim his vehicle or as long as the battery is not full.

This type of charging is not optimal, however, because the recharging does not consider constraints related to the grid, to the electric battery to be charged, or to the user of the electrical system to be recharged.

The constraints of the electrical grid to which the power supply terminal is connected can be expressed as the load curve of a transformer or of a delivery point, which is not uniform over time. For example, a transformer is stressed when the load exceeds its rated capacity.

The higher the load on the transformer, the more the transformer heats up, which accelerates its aging. In addition, large fluctuations in the load can result in sudden expansions and mechanical stresses. Ultimately, this transformer can grow louder due to the widening gaps.

As for the electric battery to be recharged, it can have widely varying charge levels when it is plugged into a power supply terminal, which determines the required amount of electrical energy to be obtained from the power supply terminal, and therefore the charging time required to reach a full charge.

Finally, concerning the constraints of the user of the electric recharging system, the user connects and disconnects the system at times which vary greatly depending on his schedule. When the electrical system is an electric car, the driver of the vehicle parks and reclaims his vehicle at times that depend on his schedule, which affects the available charging time of the power supply terminal.

The present invention seeks to overcome the above disadvantages by proposing an optimized recharging method which takes into account both the constraints related to the electrical grid and those related to the user of the electrical system to be recharged, as well as constraints related to the electric battery to be recharged, and which better protects the recharging devices of the electrical grid.

For this purpose, it proposes a method for the optimized recharging of the electric battery of at least one electrical system by an electrical recharging device, wherein the electric battery is recharged during a charging time period that is within an available charging time period initiated by the connecting of the electric battery recharging system to the electrical recharging device, this charging time period starting at a start of charge instant determined as a function of a load curve associated with the electrical recharging device, of a load limit capacity level, and of the level of residual electrical energy contained in the electric battery when the electric battery recharging system is connected to the electrical recharging device.

According to one advantageous embodiment, the determination of the start of charge instant includes the calculation, for each instant among a plurality of consecutive potential start of charge instants, of a potential load parameter that is dependent on the difference between the load curve and the load limit capacity level, and the selection of the start of charge instant corresponding to the potential start of charge instant associated with the load parameter of maximum value among all the calculated potential load parameters.

Advantageously, the calculation is an iterative calculation comprising the following steps, for a potential start of charge instant:

calculating the potential load parameter associated with the potential instant as a function of the difference between the load curve and the load limit capacity level; and comparing the duration of the time interval between the potential start of charge instant and the end time of the available charging time period, with the duration of the charging time period;

the iterative calculation being carried out for each instant among the plurality of consecutive potential start of charge instants, in chronological order, until the duration of the time interval between this potential start of charge instant and the end time of the available charging time period is less than the duration of the charging time period.

In an advantageous embodiment, the determination of the start of charge instant further comprises the sampling of the load curve over the available charging time period, in order to obtain a set of n load curve power values respectively associated with n time intervals respectively starting at n consecutive potential start of charge instants, the load parameter associated with a potential start of charge instant being equal to the sum of the respective differences, for each time interval among a plurality of consecutive time intervals starting at the potential start of charge instant, between the limit capacity level and the load curve power value associated with the time interval.

Advantageously, the determination further comprises the sampling of a load limit capacity curve over the available charging time period in order to obtain a set of n limit capacity level values respectively associated with the n time intervals respectively beginning at n consecutive potential start of charge instants, the load parameter associated with a potential start of charge instant being equal to the sum of the respective differences, for each time interval among a plurality of consecutive time intervals starting at the potential start of charge instant, between the limit capacity level value and the load curve power value which are associated with the time interval.

According to one embodiment, the available charging time period is determined as a function of the moment when the electric battery recharging system is connected to the electrical recharging device, and of an indication concerning the charging end time provided by the user of the electric vehicle.

According to another embodiment, the duration of the charging time period is determined as a function of the level of residual electrical energy contained in the electric battery when the electric battery recharging system is connected to the electrical recharging device.

Advantageously, the duration of the charging time period is equal to the difference between a charging duration corresponding to the time required to charge the electric battery to a desired level of electrical energy, and a partial charging duration corresponding the time required to charge the electric battery to the level of residual electrical energy. In one particular embodiment, the desired level of electrical energy is the maximum charge level of the electric battery.

In another embodiment, the method comprises a prior verification of the available charging time period as a function of the duration of the charging time period, the determination of the start of charge instant for the electric battery only occurring if the duration of the available charging time period is greater than the duration of the charging time period.

In one embodiment, the electric battery belongs to a class of electric batteries with a certain level of memory effect, in particular the class of NiCd or lead-acid batteries.

The present invention further provides a computer program comprising instructions for implementing the steps of the above method when it is executed by a processing unit of an electrical recharging system. Such a program is to be considered a product in the context of the protection sought by this patent application.

The present invention also provides an optimized recharging device for recharging at least one electric vehicle, connected to an electrical grid and comprising at least one connection port suitable for connection to the electric battery of an electric vehicle, the device being configured to implement the steps of the above method following the connection of the electric battery of an electric vehicle to the connection port of the optimized recharging device.

Finally, the present invention proposes an optimized recharging system for recharging a fleet composed of at least one electric vehicle, the system comprising an electrical grid and at least one electrical recharging device as described above, connected to said electrical grid. This system may preferably further comprise a remote computer system, connected to the electrical recharging device and comprising a processing unit suitable for carrying out the steps of the above method.

Other features and advantages of the invention will appear from the following detailed description and the accompanying drawings in which:

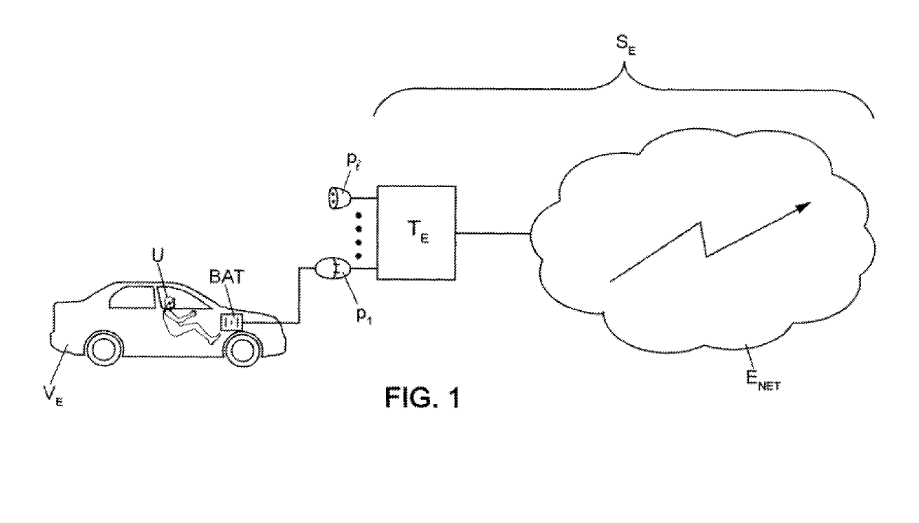

FIG. 1 illustrates an optimized system for recharging electric vehicles according to the present invention;

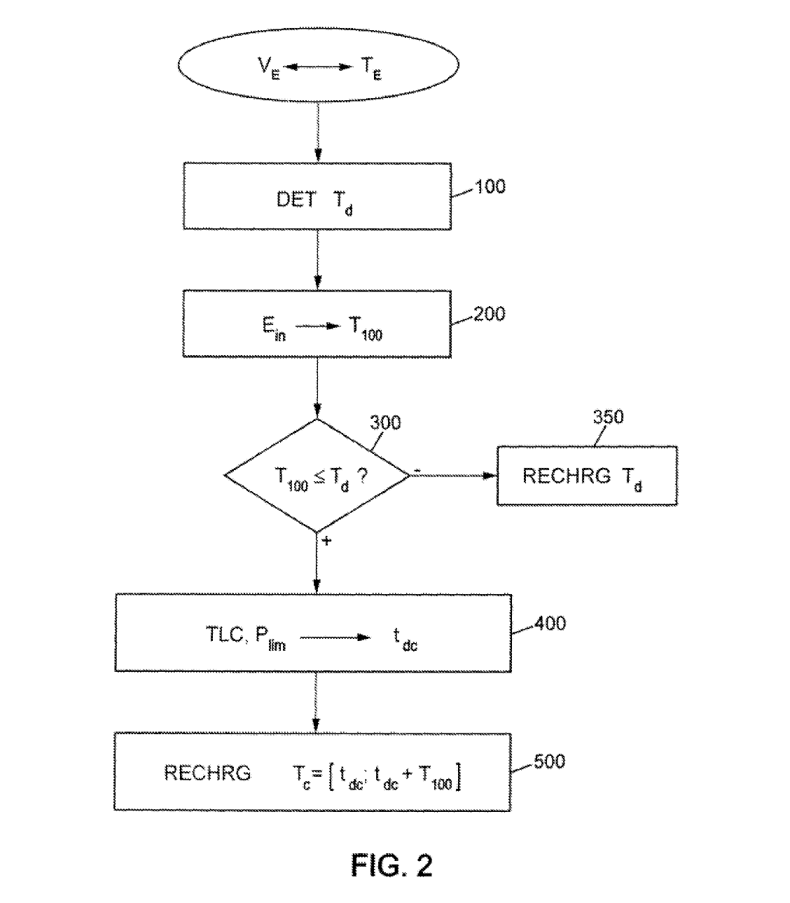

FIG. 2 illustrates the steps of an optimized method for recharging an electric vehicle according to the present invention;

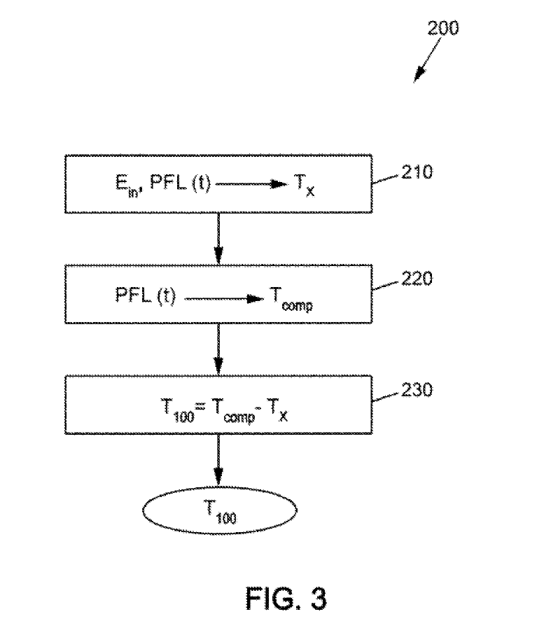

FIG. 3 illustrates an implementation of a pre-verification step of the optimized recharging method according to the present invention;

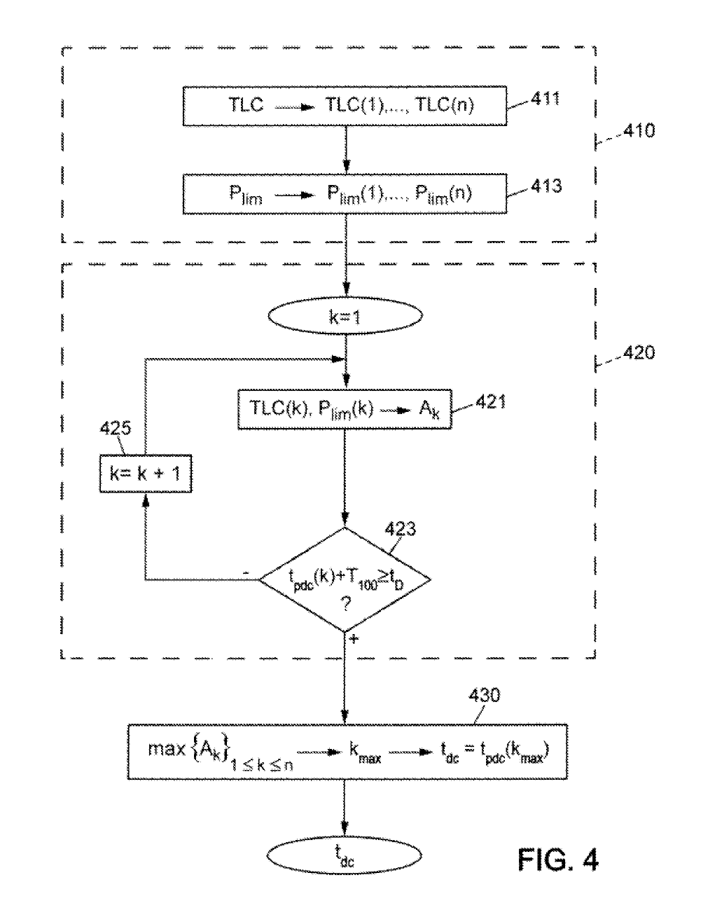

FIG. 4 illustrates an implementation of the step of determining the instant of the start of charge instant of the method according to the present invention;

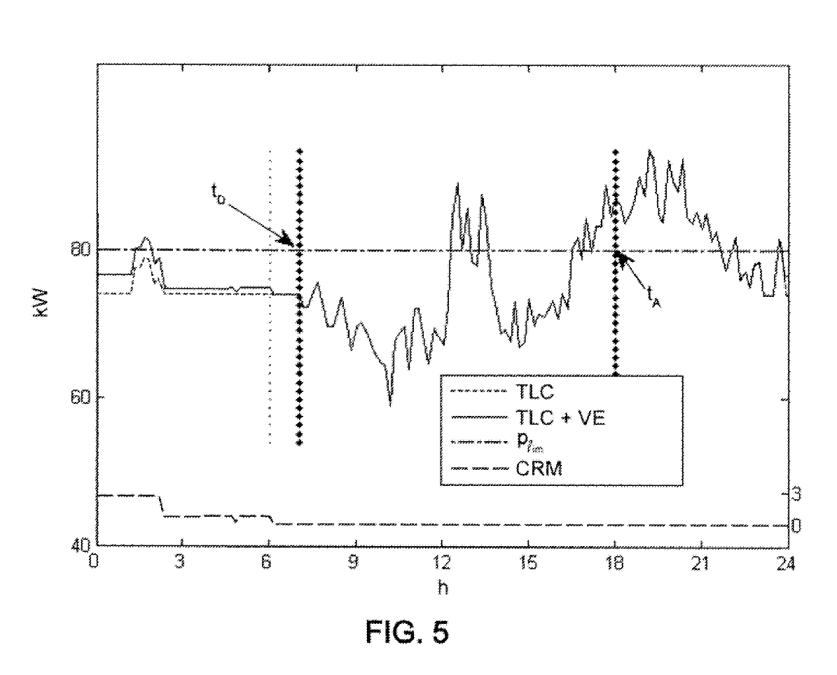

FIG. 5 represents a graph illustrating the positive effect obtained by using the optimized recharging method of the invention.

The following will first refer to FIG. 1, which illustrates an optimized system for recharging electric vehicles according to the present invention.

This optimized recharging system, designated by S_{E} in FIG. 1, comprises at least one electrical recharging device T_{E}, suitable for connecting to the recharging system for the electric battery BAT of one or more electrical systems V_{E} in order to recharge it.

A single electrical recharging device T_{E} and a single electrical system V_{E} are represented in FIG. 1, purely for illustrative purposes, but the optimized recharging system S_{E} can include any number of electrical recharging devices in order to be able to recharge any number of electrical systems.

This electrical recharging device T_{E} is itself connected to an electrical grid E_{NET} where it obtains the electrical energy required for recharging and may consist of a power transformer, for example. The device T_{E} thus has one or more connection ports p₁, . . . , p_{I} suitable for connecting to the electric battery BAT of an electrical system in order to recharge it using the electricity provided by the electrical grid E_{NET}.

The electrical system V_{E} includes one or more electric batteries BAT associated with a battery recharging system. This electrical system V_{E} is used by a user U who connects and disconnects the recharging system for this electric battery BAT to the electrical recharging device T_{E} according to his schedule.

Purely for illustrative purposes, FIG. 1 represents the electrical system V_{E} as an electric vehicle, as the present invention has particularly advantageous applications for this particular type of electrical system. In this illustrative example, the electric vehicle V_{E} is driven by a user U who connects and disconnects the recharging system for the electric battery BAT to the electrical recharging device T_{E} according to his schedule. Such an electric vehicle can be a car, a moped, or any other system having a battery that can be recharged from the electrical grid.

In the optimization of the electric recharging system V_{E}, different constraints thus apply to the optimized recharging system described in FIG. 1:
the constraints related to the recharging electrical grid, such as the load curve associated with the electrical recharging device T_{E};
the constraints related to the electric battery to be recharged, such as the charge profile of the electric battery BAT, or the electrical energy still stored in the battery when the user U plugs the battery BAT into the electrical recharging device T_{E}, and
the constraints related to the user U himself, particularly his schedule, which affect the times when he connects and disconnects the electrical system to/from the electrical recharging device T_{E}, and therefore affects the available charging time for the battery BAT.

In the present invention, the electric battery BAT of the electrical system V_{E} is recharged during at least one charging time interval ΔT_{chg}(i) within an available charging time period Td, which is initiated by connecting the recharging system for this electric battery BAT to the electrical recharging device T_{E}, which allows optimizing the recharging of this battery based on certain constraints related to the user's schedule.

The charging time interval ΔT_{chg}(i) is determined as a function of a load curve TLC associated with the electrical recharging device T_{E}, which also allows optimizing the charging of the electric battery BAT based on constraints related to the electrical recharging device T_{E}, and therefore to the optimized recharging system S_{E}.

Such a load curve TLC can be estimated at a given moment, for example on the basis of an expected load variation, or updated during charging so as to ensure ongoing load optimization according to the state of the electrical recharging device T_{E} at that moment in time. By way of illustration, the load curve TLC may be estimated on the basis of predefined load curve models or load curve models calculated from a recorded history of loads at the electrical recharging device T_{E}. Updating during charging is particularly attractive in cases where a large number of batteries are connected and are recharging at the same time, which can lead to large variations in the load curve TLC.

We will now refer to FIG. 2, which illustrates the steps of an optimized method for recharging the electric battery of an electrical system according to the present invention.

This method concerns the optimized recharging of the electric battery of one or more electrical systems V_{E} by an electrical recharging device T_{E}, the electrical system V_{E} comprising an electric battery BAT associated with a recharging system that can be connected to this electrical recharging device T_{E} in order to perform this recharging. The optimized recharging of a single electrical system V_{E} is described below for illustrative purposes, but the method can be applied to the recharging of any number of electrical systems.

This method may first include the determination (step 100) of an available charging time period Td, performed to take user constraints into account, especially his schedule, which influences the time available for recharging the electric battery BAT.

Thus, the moment t_{A} when the electric battery BAT recharging system is connected to the electrical recharging device T_{E} allows determining the start of the available charging time period Td. In other words, this moment t_{A} when the electric battery is connected begins the available charging time period Td.

To determine the moment t_{D} corresponding to the end of the available charging time period Td, it is advantageous to ask the user to indicate the time he plans to disconnect the electrical system V_{E} (for example the time he expects to reclaim his electric vehicle), for example the time he anticipates leaving for work in the morning. The user U can provide an indication concerning this charging end time t_{D}, for example via a dedicated web interface on a smartphone or on the dashboard of the electric vehicle used.

Once this available charging time period Td is determined, the method continues by determining (step 200) the duration T₁₀₀ of the charging to be applied to the electric battery BAT, as a function of the residual electrical energy Eᵢₙ contained in the electric battery BAT when it is connected to the recharging device T_{E}.

In particular, this charging duration T₁₀₀ is determined to enable recharging the electric battery to a desired level of electrical energy E, a predefined value, which typically is the maximum energy Eₘₐₓ that can be stored in this electric battery BAT, corresponding to a fully charged battery.

FIG. 3 illustrates one embodiment of such a step 200 of determining the duration T₁₀₀ of the charging time period to be applied to the electric battery.

In this embodiment, a first partial charging period Tx is first calculated (step 210), corresponding to the level of residual electrical energy Eᵢₙ remaining in the electric battery BAT when it is connected to the recharging device T_{E}.

In other words, this partial charging period Tx corresponds to the time needed to recharge the electric battery BAT from a state where it is empty of energy (a zero state of charge SoC) to the level of residual electrical energy Eᵢₙ.

In the particular case where the information available at the time of connection consists of a state of charge SoC₀ of the battery BAT, this level of residual electrical energy Eᵢₙ, is calculated beforehand using the following equation (1):

Eᵢₙ=Eₑₓₚₗ·SoC₀ (1)

where:
Eₑₓₚₗ is the usable capacity of this battery BAT; and
SoC₀ is the state of charge of the electric battery BAT at the time it is connected to the recharging device T_{E} (meaning at time t_{A} illustrated in FIG. 4).

The partial charging period Tx is then determined using the following equation (2):

$${E}_{in} = {η}_{BAT} \cdot {η}_{chrgr} {\int }_{0}^{Tx} PFL ( t ) d t , \qquad ( 2 )$$

where:
η_{BAT} is the efficiency parameter for the battery BAT, between 0 and 100%;
η_{chrgr} is the efficiency parameter for the charger for this battery BAT, also between 0 and 100%; and
PFL(t) is the charge profile for the battery BAT charging from the electrical grid.

A second charging period Tcomp, corresponding to the time required to recharge the electric battery BAT to a desired level of electrical energy E starting from a state where it is empty of energy (a zero state of charge SoC), is then determined (step 220) based on the charge profile PFL(t) of the electric battery BAT.

This second charging period Tcomp can be calculated using the following equation (3):

$$E = {η}_{BAT} \cdot {η}_{chrgr} {\int }_{0}^{Tcomp} PFL ( t ) d t \qquad ( 3 )$$

In particular, when the desired level E of electrical energy corresponds to the maximum charge level Eₘₐₓ of the electric battery BAT, then this second charging period Tcomp corresponds to a complete charging period, meaning to the time required for fully recharging the electric battery BAT starting from a state where it is empty of energy.

In this particular case, this complete charging period Tcomp is obtained using the following equation (4):

$${E}_{max} = {η}_{BAT} \cdot {η}_{chrgr} {\int }_{0}^{Tcomp} PFL ( t ) d t \qquad ( 4 )$$

where Eₘₐₓ is the maximum charge level of the electric battery BAT.

The steps of determining 210 the first partial charging period Tx and determining 220 the second charging period Tcomp are not necessarily performed in the order indicated above, but may very well be performed in the reverse order, meaning with the determination of the second charging period Tcomp preceding the determination of the first partial charging period Tx.

Once the durations Tx and Tcomp have been determined, the charging duration T₁₀₀ corresponding to the time necessary to charge the electric battery BAT from a state where it contains the residual electrical energy Eᵢₙ to a state where it contains the desired electrical energy E (typically a fully charged state at level Eₘₐₓ), can then be determined (step 230) using the following equation (5):

T₁₀₀=Tcomp−Tx (5)

To return to the optimized recharging method shown in FIG. 2, after having determined the available charging time period Td and the charging duration T₁₀₀ to be applied to the electric battery BAT, it is advantageous to verify that the available charging time period Td is sufficient, so that the optimized recharging process is only begun if such is the case. Otherwise, a conventional recharging process can be applied for the entire duration of the available charging time period Td.

To do this, a comparison (step 300) is made between the duration of the available charging time period Td and the charging duration T₁₀₀, in order to determine whether there is enough time to complete a full charge.

If this duration T₁₀₀ is less than the duration of the available charging time period Td, then it is advantageously possible to apply the optimized recharging method according to the present invention.

On the other hand, if this duration T₁₀₀ is greater than the available charging time period Td, then a full and optimized recharging of the electric battery BAT is not possible. In this latter case, a conventional recharging (step 350) can be performed in which the charge profile PFL(t), shortened by duration Tx, is applied during the entire available charging time period Td, meaning where the charging schedule during this period Td is based on a charging power having a profile corresponding to P(t)=PFL(Tx+t).

After having determined the available charging time period Td and the charging duration T₁₀₀, and possibly having verified that the duration T₁₀₀ is less than or equal to the duration of this available charging time period Td, a start of charge instant denoted t_{dc} is determined (step 400) within the available charging time period Td, as a function of the load curve TLC associated with the electrical recharging device and of a load limit capacity level denoted Pₗᵢₘ and advantageously fixed for example at 50-60% of the rated load capacity of the electrical recharging device T_{E} in order to take into account the constraints of the electrical grid (reflected by this load curve TLC of the electrical recharging device T_{E}).

The electric battery BAT is then recharged (step 500) during a charging time period Tc, contained within the available charging time period Td and starting at the start of charge instant t_{dc} and having a duration corresponding to the charging duration T₁₀₀. In other words, the charging time period Tc can be defined according to the following formula (6):

Tc=[t_{dc};t_{dc}+T₁₀₀](6)

Thus the recharging of the electric battery BAT occurs while taking into account constraints of the user (reflected by the available charging time period Td), of the electrical grid (reflected by the load curve TLC of the electrical recharging device T_{E} and the limit capacity value Pₗᵢₘ), and of the electric vehicle (reflected by the residual electrical energy Eᵢₙ still contained in the electric battery BAT at the time it is connected to the electrical recharging device T_{E}).

FIG. 4 illustrates an implementation of the step 300 of determining the instant of the start of charge instant t_{dc}, according to the present invention.

In particular, this determination comprises the calculation (step 420), for each instant t_{pdc}(k) (where k is an integer) among a plurality of consecutive potential start of charge instants t_{pdc}(1), . . . , t_{pdc}(n) (where n is an integer greater than or equal to 1) included within the available charging time period Td, of a potential load parameter Aₖ dependent on the difference between the load curve TLC and the load limit capacity level Pₗᵢₘ. Thus, for each potential start of charge instant t_{pdc}(k) there is a corresponding potential load parameter Aₖ dependent on the difference between the load curve TLC and the load limit capacity level Pₗᵢₘ.

The start of charge instant t_{dc} is then selected (step 430) as being the potential start of charge instant associated with the maximum potential load parameter Aₖₘₐₓ having the maximum value among all the calculated potential load parameters A₁, . . . , Aₙ. As this maximum potential load parameter Aₖₘₐₓ is associated with the potential start of charge instant of index kₘₐₓ, in other words with t_{pdc}(kₘₐₓ), the start of charge instant t_{dc} is therefore determined as being the potential start of charge instant t_{pdc}(kₘₐₓ).

Load parameters Aₖ are thus first calculated for a plurality of potential start of charge instants t_{pdc}(k), before selecting the potential start of charge instant t_{pdc}(kₘₐₓ) corresponding to the maximum load parameter among the calculated load parameters Aₖ.

To obtain these load parameters Aₖ, the calculation step 420 is advantageously implemented as an iterative calculation comprising the following steps, for a k^{th} potential start of charge instant t_{pdc}(k), beginning with the first potential start of charge instant t_{pdc}(1), which may correspond to the moment t_{A} when the electric battery recharging system is connected to the electrical recharging device T_{E}:
calculating (step 421) the potential load parameter Aₖ associated with the k^{th} potential instant t_{pdc}(k), as a function of the difference between the load curve TLC and the load limit capacity level Pₗᵢₘ;
then comparing (step 423) the duration of the time interval [t_{pdc}(k);t_{D}], between the k^{th} potential start of charge instant t_{pdc}(k) and the end time t_{D} of the available charging time period Td, with the duration T₁₀₀ of the charging time period Tc.

These steps are repeated for each instant t_{pdc}(k) among the plurality of consecutive potential start of charge instants, in chronological order (meaning by incrementing index k, in the order t_{pdc}(1), t_{pdc}(2), etc.) until the comparison step reveals that the duration of the time interval [t_{pdc}(k);t_{D}] is less than the duration T₁₀₀ of the charging time period Tc.

The repetition of steps 421 and 423 is symbolized in FIG. 4 by an iterative loop (step 425) that increments index k, starting from an initial value of 1.

This operation is graphically equivalent to evaluating an area between the limit capacity value Pₗᵢₘ and the load curve TLC of the electrical recharging device T_{E} within a sliding window of time of a width corresponding to the charging duration T₁₀₀, said window being slid across the available charging time period Td, starting from the moment t_{A} the electric battery BAT is connected, until the sliding window reaches the end of the available charging time period Td.

The moment chosen to begin recharging the electric battery BAT is then the one that maximizes this area as the window of time is slid across the available charging time period Td. This optimizes the recharging start time so that the recharging is primarily located at a moment where the load curve of the electrical recharging device T_{E} is minimal, and is sufficiently early for the battery to be recharged to a desired level of energy by the end of the available charging period Td.

In an advantageous embodiment, the determination step 400 comprises, prior to the calculation step 420, a sampling step 410 which allows easily manipulating data concerning the load curve TLC and/or the load limit capacity level Pₗᵢₘ, particularly for working in discrete time, which is more easily achieved using computerized means.

In particular, the load curve TLC is sampled (step 411) over the available charging time period Td in order to obtain a set {TLC(i)}_{1≦i≦n}, comprising n load curve power values TLC(1), . . . , TLC(i), . . . TLC(n) associated respectively with n time intervals ΔT(1), . . . , ΔT(i), . . . , ΔT(n) respectively starting at n consecutive potential start of charge instants t_{pdc}(1), . . . , t_{pdc}(i), . . . , t_{pdc}(n) within the available charging time period Td.

This sampling is preferably periodic, the length of the period being predetermined and corresponding to a duration of a charging time interval ΔT, a load curve power value TLC(i) then being associated with the time index i denoting the i^{th} time interval ΔT(i) contained within the available charging time period Td.

In this case, at the end of this sampling phase, the consecutive time intervals ΔT(1), . . . , ΔT(i), . . . , ΔT(n) respectively starting at n consecutive potential start of charge instants t_{pdc}(1), . . . , t_{pdc}(i), . . . , t_{pdc}(n), and respectively associated with the load curve power values TLC(1), . . . , TLC(i), . . . , TLC(n), can also be designated by a succession of time indexes 1, . . . , i, . . . n, satisfying the relation ΔT(i)=i*ΔT.

In this case, the k^{th} load parameter Aₖ, associated with the k^{th} potential start of charge instant t_{pdc}(k), is equal to the sum of the respective differences, for each time interval ΔT(i) among a plurality of consecutive time intervals ΔT(k) to ΔT(k+k₁₀₀) (where the index k₁₀₀ is an integer counting the number of consecutive time intervals after the first interval ΔT(k)) starting at the potential start of charge instant t_{pdc}(k), between the limit capacity level Pₗᵢₘ and the load curve power value TLC(i) associated with said time interval ΔT(i).

In other words, the load parameter Aₖ is obtained according to the following formula (7):

$${A}_{k} = {\sum }_{k}^{k + {k}_{100}} {P}_{lim} - TLC ( i ) \qquad ( 7 )$$

This embodiment particularly applies to cases where the limit capacity value Pₗᵢₘ is constant over the available charging time period Td.

In another embodiment where the limit capacity value Pₗᵢₘ is not constant over the available charging time period Td, but is a variable function Pₗᵢₘ(t) over this period Td, represented by a load limit capacity curve, then the sampling step 410 advantageously further comprises the sampling (step 413) of the load limit capacity curve Pₗᵢₘ(t) over the available charging time period Td in order to obtain a set of n limit capacity level values Pₗᵢₘ(1), . . . , Pₗᵢₘ(i), . . . , Pₗᵢₘ(n) respectively associated with the n time intervals ΔT(1), . . . , ΔT(i), . . . , ΔT(n) respectively starting at n consecutive potential start of charge instants t_{pdc}(1), . . . , t_{pdc}(i), . . . , t_{pdc}(n) that are within the available charging time period Td.

Thus, in this embodiment, each potential start of charge instant t_{pdc}(i) has its associated limit capacity level value Pₗᵢₘ(i) and load curve power value TLC(i), in addition to an associated time interval ΔT(i) beginning at that instant.

In this case, the load parameter Aₖ associated with the k^{th} potential start of charge instant t_{pdc}(k) is equal to the sum of the respective differences, for each time interval ΔT(i) among the plurality of consecutive time intervals ΔT(k) to ΔT(k+k₁₀₀) beginning at the potential start of charge instant t_{pdc}(k), between the limit capacity level value Pₗᵢₘ(i) and the load curve power value TLC(i) that are associated with said time interval ΔT(i).

In other words, the load parameter Aₖ is obtained here using the following formula (8):

$${A}_{k} = {\sum }_{k}^{k + {k}_{100}} {P}_{lim} ( i ) - TLC ( i ) \qquad ( 8 )$$

FIG. 5 is a graph showing the positive effect obtained when using the optimized recharging method of the invention.

This graph illustrates the load curve TLC for a transformer over the course of an entire day, as well as the curve representing the change over time of the limit capacity Pₗᵢₘ beyond which the load curve TLC causes harmful effects.

The time of arrival t_{A} of the user at 6 p.m. (i.e. the moment when an electric vehicle V_{E} is connected to the transformer) and the time of departure t_{D} of the user at about 7 a.m. (i.e. the moment when the electric vehicle V_{E} is disconnected from the supply terminal) are indicated, defining an available charging period Td that is equivalent to the interval [t_{A};t_{D}].

At the bottom of this graph one can see the curve CRM representing the variation over time of the charging power applied to the electric battery BAT.

It is particularly apparent in this curve CRM that the charge applied to the electric battery BAT is primarily at its maximum at the moments where the load curve TLC is at its minimum or is at least below the limit capacity level Pₗᵢₘ. Also, charging period Tc is a continuous period located between 0 and 6 a.m., which would allow reaching the desired charge level by the time of departure t_{D} anticipated by the user.

The resulting load curve, designated by TLC+VE, is illustrated as well. It is clear from this resulting load curve that it is mainly the low points in the load curve TLC, located below the limit capacity level Pₗᵢₘ, which are raised by the optimized recharging of the vehicle V_{E}.

As a result, the increase in the load curve induced by recharging the vehicle V_{E} is primarily confined to the minimal load values in the load curve TLC, which limits the negative effects on the transformer, unlike the case where charging is continuously enabled throughout the period [t_{A};t_{D}].

The different steps of the optimized recharging method described above can be implemented by a program suitable for execution by a processing unit of an optimized recharging system, for example implemented as a computer or a data processor, said program comprising instructions for controlling the execution of the steps of a method as mentioned above.

In particular, the processing unit in question may be located within the optimized recharging device T_{E} or within the electrical system V_{E}, in order to locally manage the recharging of the electric vehicles.

Or the processing unit in question may be located remotely from the optimized recharging device T_{E}, in a remote computer system that is part of the optimized recharging system S_{E}, in order to manage the recharging centrally, which is appropriate for the case of a large fleet. In such a case, instructions are communicated to the optimized recharging device T_{E} or to the electrical system V_{E} via various telecommunication networks in order to manage the optimized recharging.

As for the program, it can use any programming language, and may be in the form of source code, object code, or intermediate code between source code and object code, such as in a partially compiled form, or in any other desirable form.

The invention also concerns a medium readable by a computer or data processor, and containing the instructions of a program as mentioned above. This medium may be any entity or device capable of storing the program. For example, the medium may consist of a storage medium such as a ROM, for example a CD-ROM or a microelectronic circuit ROM, or a magnetic recording medium such as a diskette or hard disk.

On the other hand, the medium may be a transmissible medium such as an electrical, optical, or electromagnetic signal, which may be conveyed via electrical or optical cable, by radio, or by other means. The program according to the invention may in particular be downloaded over a network such as the Internet. Alternatively, the medium may be an integrated circuit incorporating the program, the circuit being adapted to execute or to be used in executing the method in question.

The optimized recharging method of the invention is particularly advantageous for applications involving the recharging of electric batteries where recharging with pauses/interruptions is not recommended, or for certain battery technologies having a certain memory effect, for example NiCd batteries or lead-acid batteries.

Of course, the invention is not limited to the embodiments described and illustrated above; one can conceive of other embodiments and other implementations without departing from the scope of the invention.

The electrical system was illustrated above in the form of an electric vehicle. However, the electrical system V_{E} can very well be in the form of any electrical system having capacities for storing electrical energy, such as a mobile phone having a rechargeable battery.

1. A method for the optimized recharging of the electric battery of at least one electrical system by an electrical recharging device, wherein the electric battery is recharged during a charging time period that is within an available charging time period initiated by the connecting of the electric battery recharging system to the electrical recharging device, said charging time period starting at a start of charge instant determined as a function of a load curve associated with said electrical recharging device, of a load limit capacity level, and of the level of residual electrical energy contained in the electric battery when the electric battery recharging system is connected to the electrical recharging device.

2. The optimized recharging method according to claim 1, wherein the determination of the start of charge instant comprises:
calculating, for each instant among a plurality of consecutive potential start of charge instants, a potential load parameter that is dependent on the difference between the load curve and the load limit capacity level, and
selecting the start of charge instant corresponding to the potential start of charge instant associated with the load parameter of maximum value among all the calculated potential load parameters.

3. The optimized recharging method according to claim 2, wherein the calculation is an iterative calculation comprising the followings steps, for a potential start of charge instant:
calculating the potential load parameter associated with said potential instant as a function of the difference between the load curve and the load limit capacity level; and
comparing the duration of the time interval between said potential start of charge instant and the end time of the available charging time period, with the duration of the charging time period;
the iterative calculation being carried out for each instant among the plurality of consecutive potential start of charge instants, in chronological order, until the duration of the time interval between said potential start of charge instant and the end time of the available charging time period is less than the duration of the charging time period.

4. The optimized recharging method according to claim 1, wherein the determination of the start of charge instant further comprises the sampling of the load curve over the available charging time period, in order to obtain a set of n load curve power values respectively associated with n time intervals respectively starting at n consecutive potential start of charge instants;
the load parameter associated with a potential start of charge instant being equal to the sum of the respective differences, for each time interval among a plurality of consecutive time intervals starting at the potential start of charge instant, between the limit capacity level and the load curve power value associated with said time interval.

5. The optimized recharging method according to claim 4, wherein the determination further comprises the sampling of a load limit capacity curve over the available charging time period in order to obtain a set of n limit capacity level values respectively associated with the n time intervals respectively beginning at n consecutive potential start of charge instants;
the load parameter associated with a potential start of charge instant being equal to the sum of the respective differences, for each time interval among a plurality of consecutive time intervals starting at the potential start of charge instant, between the limit capacity level value and the load curve power value which are associated with said time interval.

6. The optimized recharging method according to claim 1, wherein the available charging time period is determined as a function of the moment when the electric battery recharging system is connected to the electrical recharging device and of an indication concerning the charging end time provided by the user of the electric vehicle.

7. The optimized recharging method according to claim 1, wherein the duration of the charging time period is determined as a function of the level of residual electrical energy contained in the electric battery when the electric battery recharging system is connected to the electrical recharging device.

8. The optimized recharging method according to claim 7, wherein the duration of the charging time period is equal to the difference between a charging duration corresponding to the time required to charge the electric battery to a desired level of electrical energy, and a partial charging duration corresponding to the time required to charge the electric battery to the level of residual electrical energy.

9. The optimized recharging method according to claim 8, wherein the desired level of electrical energy is the maximum charge level of the electric battery.

10. The optimized recharging method according to claim 1, comprising a prior verification of the available charging time period as a function of the duration of the charging time period the determination of the start of charge instant for the electric battery only occurring if the duration of the available charging time period is greater than the duration of the charging time period.

11. The optimized recharging method according to claim 1, wherein the electric battery belongs to a class of electric batteries having a certain level of memory effect, particularly the class of NiCd or lead-acid batteries.

12. A non-transitory computer readable storage medium, having stored thereon a computer program comprising program instructions, the computer program being loadable into a data-processing unit and adapted to cause the data-processing unit to carry out the steps of claim 1 when the computer is run by the data-processing device.

13. An optimized recharging device for recharging at least one electric vehicle, connected to an electrical grid and comprising at least one connection port suitable for connection to the electric battery of an electric vehicle, the device being configured to implement the steps of the method according to claim 1 following the connection of the electric battery of an electric vehicle to the connection port of the optimized recharging device.

14. An optimized recharging system for electrically recharging a fleet composed of at least one electric vehicle, the system comprising an electrical grid and at least one electrical recharging device according to claim 13, connected to said electrical grid.

15. The optimized recharging system according to claim 14, further comprising a remote computer system, connected to the electrical recharging device and comprising a processing unit suitable for carrying out the steps of a method for the optimized recharging of the electric battery of at least one electrical system by an electrical recharging device, wherein the electric battery is recharged during a charging time period that is within an available charging time period initiated by the connecting of the electric battery recharging system to the electrical recharging device, said charging time period starting at a start of charge instant determined as a function of a load curve associated with said electrical recharging device, of a load limit capacity level, and of the level of residual electrical energy contained in the electric battery when the electric battery recharging system is connected to the electrical recharging device.
